(19) United States
(12) Patent Application Publication
(10) Pub. No.: US 2015/0037505 A1
(43) Pub. Date: Feb. 5, 2015

(54) LUBRICANT SOLUTION AND METHOD FOR PRODUCING ARTICLE PROVIDED WITH LUBRICANT COATING FILM

(71) Applicant: ASAHI GLASS COMPANY, LIMITED, Chiyoda-ku (JP)

(72) Inventors: Masaaki TSUZAKI, Chiyoda-ku (JP); Mai Hashimoto, Chiyoda-ku (JP); Hiroaki Mitsuoka, Chiyoda-ku (JP)

(73) Assignee: ASAHI GLASS COMPANY, LIMITED, Chiyoda-ku (JP)

(21) Appl. No.: 14/513,913

(22) Filed: Oct. 14, 2014

Related U.S. Application Data
(63) Continuation of application No. PCT/JP2013/061675, filed on Apr. 19, 2013.

(30) Foreign Application Priority Data
Apr. 23, 2012 (JP) 2012-097857

(51) Int. Cl. C10M 105/54; B05D 3/00; B05D 1/18; B05D 1/28; B05D 1/02

(52) U.S. Cl. CPC C10M 105/54; B05D 1/28; B05D 1/02; B05D 1/18; B05D 3/007
USPC 427/385.5; 508/590; 508/583; 508/582; 508/307; 508/524

(57) ABSTRACT

To provide a lubricant solution which does not impair the global environment, which provides an excellent solubility of a lubricant, which has a sufficient drying property and with which a uniform lubricant coating film can be formed, and a method for producing an article provided with a lubricant coating film, using the lubricant solution.

A lubricant solution which is a solution of a lubricant, wherein the solvent is a solvent containing 1,1-dichloro-2,3,3,3-tetrafluoro-1-propene. A method for producing an article provided with a lubricant coating film, which comprises applying the lubricant solution to an object to be coated, and evaporating the solvent to form a lubricant coating film on the object.

### TECHNICAL FIELD

The present invention relates to a lubricant solution, and a method for producing an article provided with a lubricant coating film.

### BACKGROUND ART

As a method for producing an article having a coating film containing an organic chemical substance such as a lubricant, for example, a method has been known in which a solution having such an organic chemical substance dissolved in a diluting solvent is prepared, the solution is applied to an object to be coated and then the diluting solvent is evaporated to form a coating film. The diluting solvent is required to be capable of sufficiently dissolving an organic chemical substance and to have a sufficient drying property.

Heretofore, for the diluting solvent, a fluorinated solvent containing e.g. a chlorofluorocarbon (hereinafter referred to as “CFC”) such as 1,1,2-trichloro-1,2,2-trifluoroethane or a hydrochlorofluorocarbon (hereinafter referred to as “HCFC”) such as 2,2-dichloro-1,1,1-trifluoroethane, 1,1-dichloro-1-fluoroethane, 3,3-dichloro-1,1,1,2,2-pentafluoropropane or 1,3-dichloro-1,1,2,2,3-pentafluoropropane has been used in view of excellence in non-combustibility and chemical and thermal stability.

However, CFCs which are chemically very stable have a long life in the troposphere after vaporization and are diffused and reach even the stratosphere. Accordingly, the CFCs which reached the stratosphere are decomposed by ultraviolet light to form chlorine radicals, thus leading to destruction of the ozone layer. Thus, production of CFCs is globally restricted, and their production is totally abolished in advanced countries.

Further, HCFCs also have chlorine atoms and impair the ozone layer slightly though, and accordingly their production is to be totally abolished in 2020 in advanced countries.

On the other hand, as a solvent which has no chlorine atom and which will not impair the ozone layer, a perfluorocarbon (hereinafter referred to as “PFC”) has been known (Patent Document 1). Further, as an alternative solvent to the CFCs and the HCFCs, a hydrofluorocarbon (hereinafter referred to as “HFC”), a hydrofluoroether (hereinafter referred to as “HFE”), etc. have been developed (Patent Documents 2 and 3).

### PRIOR ART DOCUMENTS

### Patent Documents

Patent Document 1: JP-A-4-119523

Patent Document 2: JP-A-6-510821

Patent Document 3: JP-A-2009-507840

### DISCLOSURE OF INVENTION

### Technical Problem

However, the HFCs and the PFCs are substances to be controlled by the Kyoto Protocol. Further, the range of application of the HFCs, the HFEs and the PFCs is narrow as a diluting solvent for a lubricant, since the solubility of organic chemical substances such as the lubricant is low in these solvents.

The object of the present invention is to provide a lubricant solution which will not impair the global environment, and which is excellent in the solubility of the lubricant, has a sufficient drying property and is capable of easily forming a uniform lubricant coating film, and a method for producing an article provided with a lubricant coating film using the lubricant solution.

### Solution to Problem

The present invention provides a lubricant solution which contains 1,1-dichloro-2,3,3,3-tetrafluoro-1-propene as the solvent.

In the lubricant solution of the present invention, the lubricant is preferably a fluorinated lubricant or a silicone lubricant. The content of the solvent in the lubricant solution is preferably from 50 to 99.99 mass %.

Further, the solvent preferably comprises 1,1-dichloro-2,3,3,3-tetrafluoro-1-propene and an organic solvent soluble in 1,1-dichloro-2,3,3,3-tetrafluoro-1-propene.

Further, the organic solvent is preferably an organic solvent selected from the group consisting of a hydrocarbon, an alcohol, a ketone, an ether, an ester, a chlorocarbon, a HFC and a HFE.

Further, the hydrocarbon is preferably n-pentane, cyclopentane, n-hexane, cyclohexane or n-heptane, the alcohol is preferably methanol, ethanol or isopropyl alcohol, the ketone is preferably acetone or methyl ethyl ketone. Further, the ether is preferably diethyl ether, diisopropyl ether or tetrahydrofuran, the ester is preferably methyl acetate or ethyl acetate, and the chlorocarbon is preferably methylene chloride, trans-1,2-dichloroethylene or trichloroethylene. Further, the HFC is preferably 1,1,1,2,2,3,4,5,5,5-decafluoropentane, 1,1,1,2,2,3,3,4,4-nonafluorohexane or 1,1,1,2,2,3,3,4,4,5,5,6,6-tridecafluorohexane, and the HFE is preferably (perfluorobutoxy)methane or 1,1,2,2-tetrafluoro-1-(2,2,2-trifluoroethoxy)ethane.

Further, the content of the organic solvent in the solvent is preferably from 0.1 to 50 mass %.

The method for producing an article provided with a lubricant coating film of the present invention is a method which comprises applying the lubricant solution of the present invention to an object to be coated, and evaporating the solvent to form a lubricant coating film on the object.

### ADVANTAGEOUS EFFECTS OF INVENTION

The lubricant solution of the present invention will not impair the global environment, and is excellent in the solubility of the lubricant, has a sufficient drying property and is capable of easily forming a uniform lubricant coating film.

Further, according to the method for producing an article provided with a lubricant coating film, an article provided with a lubricant coating film, which has a lubricant coating film, can easily be produced by the lubricant solution of the present invention without impairing the global environment.

### DESCRIPTION OF EMBODIMENTS

### <Lubricant Solution>

The lubricant solution of the present invention is a solution containing a lubricant and a solvent (hereinafter referred to as “solvent (A)”) containing 1,1-dichloro-2,3,3,3-tetrafluoro-1-propene (hereinafter referred to as “CFO-1214ya”).

### [Solvent (A)]

CFO-1214ya contained in the solvent (A) is an olefin having a double bond between carbon atoms and thereby has short life in the air and has low ozone destruction potential and low global warming potential. Further, CFO-1214ya has a boiling point of about 46° C. and is thereby excellent in the drying property. Further, even when it is boiled and formed into vapor, its temperature is about 46° C., and it thereby hardly impair even a component which is susceptible to heat, such as a resin member. Further, CFO-1214ya does not have a flash point. Further, CFO-1214ya has excellent performance as a diluting solvent for a lubricant, such that it has a low surface tension and a low viscosity, and it is easily evaporated even at room temperature. Further, according to studies by the present inventors, it was found that CFO-1214ya provides excellent solubility of a lubricant and has sufficient performance as a diluting solvent for a lubricant.

CFO-1214ya may be produced, for example, by a method (1) of subjecting 1,1-dichloro-2,2,3,3,3-pentafluoropropane (hereinafter referred to as “HCFC-225ca”) as a raw material to dehydrofluorination in an alkaline aqueous solution in the presence of a phase transfer catalyst, or a method (2) of subjecting HCFC-225ca as a raw material to dehydrofluorination in a vapor phase in the presence of a catalyst such as chromium, iron, copper or activated carbon (Japanese Patent No. 3778298). Further, it may also be produced by the method (1) or (2) wherein an isomer mixture of HCFC-225ca and 1,3-dichloro-1,2,2,3,3-pentafluoropropane (hereinafter referred to as “HCFC-225cb”) as a raw material is used and HCFC-225ca is subjected to dehydrofluorination (WO2010/074254). The method of using an isomer mixture is advantageous in view of easiness and economical efficiency.

In the CFO-1214ya obtained by the above production method, impurities such as unreacted HCFC-225ca or HCFC-225cb are present. The content of impurities in CFO-1214ya to be used is preferably at most 1 mass %, more preferably at most 0.5 mass % so as to reduce the burden to global environment, such as ozone layer destruction or global warming, and to maintain the solubility of the lubricant.

That is, the purity of CFO-1214ya is preferably at least 99 mass %, more preferably at least 99.5 mass %.

The purity of CFO-1214ya can be increased e.g. by distillation.

The moisture content of CFO-1214ya is preferably at most 50 mass ppm, more preferably at most 10 mass ppm. When the moisture content of CFO-1214ya is at most the above upper limit, degeneration e.g. by decomposition of CFO-1214ya e.g. during storage can be suppressed.

To remove the moisture in CFO-1214ya, for example, a method using zeolite as a dehydrating agent may be mentioned. Zeolite may be a natural product or may be a synthetic product, and preferred is synthetic zeolite in view of stable quality and availability.

Specifically, preferred are tradenames “Molecular Sieve 3A”, “Molecular Sieve 4A”, “Molecular Sieve 5A” and “Molecular Sieve 13X” (each manufactured by Union Carbide Corporation), and “Zeolum A-3”, “Zeolum A-4”, “Zeolum A-5” and “Zeolum F-9” (each manufactured by TOSOH CORPORATION), etc. Among them, preferred are 3A type and 4A type such as “Molecular Sieve 3A”, “Molecular Sieve 4A”, “Zeolum A-3” and

“Zeolum A-4”.

The solvent (A) preferably contains, in addition to CFO-1214ya, an organic solvent (hereinafter referred to as “organic solvent (Al)”) soluble in CFO-1214ya, depending upon various purposes of use, such as an increase of the solubility or control of the volatilization rate. Here, “soluble in CFO-1214ya” means that the organic solvent (A1) can be uniformly dissolved without phase separation or turbidity by mixing it with CFO-1214ya at a predetermined concentration, followed by stirring at room temperature (25° C.).

The organic solvent (A1) is preferably an organic solvent selected from the group consisting of a hydrocarbon, an alcohol, a ketone, a ether, an ester, a chlorocarbon, a HFC and a HFE which are soluble in CFO-1214ya.

The hydrocarbon soluble in CFO-1214ya is preferably a hydrocarbon having at least 5 carbon atoms. The hydrocarbon may be chain-like or cyclic, and may be a saturated hydrocarbon or an unsaturated hydrocarbon.

Specifically, it may, for example, be n-pentane, 2-methylbutane, n-hexane, 2-methylpentane, 2,2-dimethylbutane, 2,3-dimethylbutane, n-heptane, 2-methylhexane, 3-methylhexane, 2,4-dimethylpentane, n-octane, 2-methylheptane, 3-methylheptane, 4-methylheptane, 2,2-dimethylhexane, 2,5-dimethylhexane, 3,3-dimethylhexane, 2-methyl-3-ethylpentane, 3-methyl-3-ethylpentane, 2,3,3-trimethylpentane, 2,3,4-trimethylpentane, 2,2,3-trimethylpentane, 2-methylheptane, 2,2,4-trimethylpentane, n-nonane, 2,2,5-trimethylhexane, n-decane, n-dodecane, 2-methyl-2-butene, 1-pentene, 2-pentene, 1-hexene, 1-octene, 1-nonene, 1-decene, cyclopentane, methylcyclopentane, cyclohexane, methylcyclohexane, ethylcyclohexane, bicyclohexane, cyclohexene, α-pinene, dipentene, decalin or tetralin or amyl naphthalene. Among them, more preferred is n-pentane, cyclopentane, n-hexane, cyclohexane or n-heptane.

The alcohol soluble in CFO-1214ya is preferably a C1-16 alcohol. Such an alcohol may be chain-like or cyclic, and may be a saturated alcohol or an unsaturated alcohol.

Specifically, it may, for example, be methanol, ethanol, n-propyl alcohol, isopropyl alcohol, n-butyl alcohol, sec-butyl alcohol, isobutyl alcohol, tert-butyl alcohol, 1-pentanol, 2-pentanol, 1-ethyl-1-propanol, 2-methyl-1-butanol, 3-methyl-1-butanol, 3-methyl-2-butanol, neopentyl alcohol, 1-hexanol, 2-methyl-1-pentanol, 4-methyl-2-pentanol, 2-ethyl-1-butanol, 1-heptanol, 2-heptanol, 3-heptanol, 1-octanol, 2-octanol, 2-ethyl-1-hexanol, 1-nonanol, 3,5,5-trimethyl-1-hexanol, 1-decanol, 1-undecanol, 1-dodecanol, allyl alcohol, propargyl alcohol, benzyl alcohol, cyclohexanol, 1-methyl cyclohexanol, 2-methyl cyclohexanol, 3-methyl cyclohexanol, 4-methyl cyclohexanol, α-terpineol, 2,6-dimethyl-4-heptanol, nonyl alcohol or tetradecyl alcohol. Among them, preferred is methanol, ethanol or isopropyl alcohol.

The ketone soluble in CFO-1214ya is preferably a C3-9 ketone. Such a ketone may be chain-like or cyclic, and may be a saturated ketone or an unsaturated ketone.

Specifically, it may, for example, be acetone, methyl ethyl ketone, 2-pentanone, 3-pentanone, 2-hexanone, methyl isobutyl ketone, 2-heptanone, 3-heptanone, 4-heptanone, diisobutyl ketone, mesityl oxide, phorone, 2-octanone, cyclohexanone, methylcyclohexanone, isophorone, 2,4-pentanedione, 2,5-hexanedione, diacetone alcohol or acetophenone. Among them, preferred is acetone or methyl ethyl ketone.

The ether soluble in CFO-1214ya is preferably a C2-8 ether. Such an ether may be chain-like or cyclic, and may be a saturated ether or an unsaturated ether.

Specifically, it may, for example, be diethyl ether, dipropyl ether, diisopropyl ether, dibutyl ether, ethyl vinyl ether, butyl vinyl ether, anisole, phenetole, methyl anisole, furan, methylfuran or tetrahydrofuran. Among them, preferred is diethyl ether, diisopropyl ether or tetrahydrofuran.

The ester soluble in CFO-1214ya is preferably a C2-19 ester. Such an ester may be chain-like or cyclic, and may be a saturated ester or an unsaturated ester.

Specifically, it may, for example, be methyl formate, ethyl formate, propyl formate, butyl formate, isobutyl formate, pentyl formate, methyl acetate, ethyl acetate, propyl acetate, isopropyl acetate, butyl acetate, isobutyl acetate, sec-butyl acetate, pentyl acetate, methoxybutyl acetate, sec-hexyl acetate, 2-ethylbutyl acetate, 2-ethylhexyl acetate, cyclohexyl acetate, benzyl acetate, methyl propionate, ethyl propionate, butyl propionate, methyl butyrate, ethyl butyrate, butyl butyrate, isobutyl isobutyrate, ethyl 2-hydroxy-2-methylpropionate, methyl benzoate, ethyl benzoate, propyl benzoate, butyl benzoate, benzyl benzoate, y-butyrolactone, diethyl oxalate, dibutyl oxalate, dipentyl oxalate, diethyl malonate, dimethyl maleate, diethyl maleate, dibutyl maleate, dibutyl tartrate, tributyl citrate, dibutyl sebacate, dimethyl phthalate, diethyl phthalate or dibutyl phthalate. Among them, preferred is methyl acetate or ethyl acetate.

The chlorocarbon soluble in CFO-1214ya is preferably a C1-3 chlorocarbon. Such a chlorocarbon may be chain-like or cyclic, and may be a saturated chlorocarbon or an unsaturated chlorocarbon.

Specifically, it may, for example, be methylene chloride, 1,1-dichloroethane, 1,2-dichloroethane, 1,1,2-trichloroethane, 1,1,1,2-tetrachloroethane, 1,1,2,2-tetrachloroethane, pentachloroethane, 1,1-dichloroethylene, cis-1,2-dichloroethylene, trans-1,2-dichloroethylene, trichloroethylene, tetrachloroethylene or 1,2-dichloropropane. Among them, preferred is methylene chloride, trans-1,2-dichloroethylene or trichloroethylene. The HFC soluble in CFO-1214ya is preferably a C4-8 chain-like or cyclic HFC, more preferably a HFC in which the number of fluorine atoms in one molecule is the same or larger than the number of hydrogen atoms.

Specifically, it may, for example, be 1,1,1,3,3-pentafluorobutane, 1,1,1,2,2,3,4,5,5,5-decafluoropentane, 1,1,2,2,3,3,4-heptafluorocyclopentane, 1,1,1,2,2,3,3,4,4-nonafluorohexane, 1,1,1,2,2,3,3,4,4,5,5,6,6-tridecafluorohexane or 1,1,1,2,2,3,3,4,4,5,5,6,6-tridecafluorooctane. Among them, preferred is 1,1,1,2,2,3,4,5,5,5-decafluoropentane, 1,1,1,2,2,3,3,4,4-nonafluorohexane or 1,1,1,2,2,3,3,4,4,5,5,6,6-tridecafluorohexane.

The HFE soluble in CFO-1214ya may, for example, be (perfluorobutoxy)methane, (perfluorobutoxy)ethane or 1,1,2,2-tetrafluoro-1-(2,2,2-trifluoroethoxy)ethane. Among them, preferred is (perfluorobutoxy)methane or 1,1,2,2-tetrafluoro-1-(2,2,2-trifluoroethoxy)ethane.

The organic solvent (A1) contained in the solvent (A) may be one type or two or more types. Further, in a case where two or more organic solvents (A1) are contained, the combination may be a combination of solvents in the same category or may be a combination of solvents in different categories. For example, the combination may be a combination of two types selected from hydrocarbons or may be a combination of one type selected from hydrocarbons and one type selected from alcohols.

The organic solvent (A1) is more preferably a solvent having no flash point. The organic solvent (A1) having no flash point may be a HFC such as 1,1,1,2,2,3,4,5,5,5-decafluoropentane, 1,1,1,2,2,3,3,4,4-nonafluorohexane or 1,1,1,2,2,3,3,4,4,5,5,6,6-tridecafluorohexane, or a HFE such as (perfluorobutoxy)methane or 1,1,2,2-tetrafluoro-1-(2,2,2-trifluoroethoxy)ethane. Even in a case where a solvent having a flash point is used as the organic solvent (A1), it is preferably used as mixed with CFO-1214ya within a range where the solvent (A) does not have a flash point.

Further, in a case where CFO-1214ya and the organic solvent (A1) forms an azeotropic composition, the solvent (A) may be used as an azeotropic composition.

The content of the solvent (A) in the lubricant solution (100 mass %) of the present invention is preferably from 50 to 99.99 mass %, more preferably from 70 to 99.95 mass %, further preferably from 80 to 99.9 mass %.

When the content of the solvent (A) is at least the lower limit value and at most the upper limit value, the film thickness of the coating film when the lubricant solution is applied and the thickness of the lubricant coating film after drying are readily be adjusted within proper ranges.

The content of CFO-1214ya in the solvent (A) (100 mass %) is preferably at least 50 mass %, more preferably at least 80 mass %, further preferably at least 90 mass %. When the content of CFO-1214ya is at least the lower limit value, the excellent drying property which CFO-1214ya has will not be impaired.

The upper limit of the content of CFO-1214ya is 100 mass %.

The content of the organic solvent (A1) in the solvent (A) (100 mass %) is preferably from 0.1 to 50 mass %, more preferably from 0.5 to 20 mass %, further preferably from 1 to 10 mass %.

When the content of the organic solvent (A1) is at least the lower limit value, the effect of the organic solvent (A1) will be sufficiently obtained. When the content of the organic solvent (A1) is at most the upper limit value, the excellent drying property which CFO-1214ya has will not be impaired.

The content of CFO-1214ya in the lubricant solution (100 mass %) of the present invention is preferably from 25 to 99.99 mass %, more preferably from 96 to 99.95 mass %, further preferably from 72 to 99.9 mass %.

The content of the organic solvent (A1) in the lubricant solution (100 mass %) of the present invention is preferably from 0.05 to 49.99 mass %, more preferably from 0.35 to 19.99 mass %, further preferably from 0.8 to 9.99 mass %.

### [Lubricant]

A lubricant means one to be used to reduce friction on the contact surface and to prevent generation of heat and damages by abrasion when two members are moved in a state where their surfaces are in contact with each other. The lubricant may be in any state of a liquid (oil), a semi-solid (grease) and a solid.

The lubricant is preferably a fluorinated lubricant or a silicone lubricant in view of excellent solubility in CFO-1214ya. A fluorinated lubricant means a lubricant having fluorine atoms in its molecule. Further, a silicon lubricant means a lubricant containing silicone.

The fluorinated lubricant may, for example, be a fluorinated oil, a fluorinated grease or a fluorinated solid lubricant such as a resin powder of polytetrafluoroethylene.

The fluorinated oil is preferably an oligomer of perfluoro polyether or chlorotrifluoroethylene. It may, for example, be tradenames “Krytox (registered trademark) GPL102” (manufactured by DuPont), “DAIFLOIL #1”, “DAIFLOIL #3”, “DAIFLOIL #10”, “DAIFLOIL #20”, “DAIFLOIL #50”, “DAIFLOIL #100” or “DEMNUM S-65” (manufactured by DAIKIN INDUSTRIES Ltd.).

The fluorinated grease is preferably one comprising a fluorinated oil such as an oligomer of perfluoro polyether or chlorotrifluoroethylene as a base oil and having a powder of polytetrafluoroethylene or another thickener incorporated. It may, for example, be tradenames “Krytox (registered trademark) grease 240AC” (manufactured by DuPont), “DAIFLOIL grease DG-203”, “DEMNUM L65”, “DEMNUM L100” or “DEMNUM L200” (each manufactured by DAIKIN INDUSTRIES Ltd.), “Sumitec F936” (manufactured by SUMICO LUBRICANT CO., LTD.), “MOLYKOTE (registered trademark) HP-300”, “MOLYKOTE (registered trademark) HP-500”, “MOLYKOTE (registered trademark) HP-870” or “MOLYKOTE (registered trademark) 6169”.

The silicone lubricant may, for example, be a silicone oil or a silicone grease. The silicone oil is preferably dimethyl silicone, methyl hydrogen silicone, methyl phenyl silicone, cyclic dimethyl silicone or a denatured silicone oil having an organic group introduced to the side chain or the terminal. It may, for example, be tradenames “Shin-Etsu Silicone KF-96”, “Shin-Etsu Silicone KF-965”, “Shin-Etsu Silicone KF-968”, “Shin-Etsu Silicone KF-99”, “Shin-Etsu Silicone KF-50”, “Shin-Etsu Silicone KF-54”, “Shin-Etsu Silicone HIVAC F-4”, “Shin-Etsu Silicone HIVAC F-5”, “Shin-Etsu Silicone KF-56A” or “Shin-Etsu Silicone KF-995” (each manufactured by Shin-Etsu Chemical Co., Ltd.) or “SH200” (manufactured by Dow Corning Toray Co., Ltd.).

The silicone grease is preferably a product comprising the above silicone oil as a base oil and having a thickener such as metal soap or various additives incorporated. It may, for example, be tradenames “Shin-Etsu silicone G-30 series”, “Shin-Etsu silicone G-40 series”, “Shin-Etsu silicone FG-720 series”, “Shin-Etsu silicone G-411”, “Shin-Etsu silicone G-501”, “Shin-Etsu silicone G-6500”, “Shin-Etsu silicone G-330”, “Shin-Etsu silicone G-340”, “Shin-Etsu silicone G-350” or “Shin-Etsu silicone G-630” (each manufactured by Shin-Etsu Chemical Co., Ltd.), “MOLYKOTE (registered trademark) SH33L”, “MOLYKOTE (registered trademark) 41”, “MOLYKOTE (registered trademark) 44”, “”MOLYKOTE (registered trademark) 822M”, “MOLYKOTE (registered trademark) 111”, “MOLYKOTE (registered trademark) high vacuum grease” or “MOLYKOTE (registered trademark) heat sink compound” (each manufactured by Dow Corning Toray Co., Ltd.).

Further, as a lubricant which may be exemplified both as a fluorinated lubricant and as a silicone lubricant, a fluorosilicone oil which is a denatured silicone oil having its terminal or side chain replaced with a fluoroalkyl group may be mentioned. It may, for example, be tradenames “UNIDYNE (registered trademark) TG-5601” (manufactured by DAIKIN INDUSTRIES Ltd.), “MOLYKOTE (registered trademark) 3451” or “MOLYKOTE (registered trademark) 3452” (each manufactured by Dow Corning Toray Co., Ltd.) or “Shin-Etsu Silicone FL-5”, “Shin-Etsu Silicone X-22-821”, “Shin-Etsu Silicone X-22-822” or “Shin-Etsu Silicone FL-100” (each manufactured by Shin-Etsu Chemical Co., Ltd.).

The lubricant contained in the lubricant solution of the present invention may be one type or two or more types. Each of the fluorinated lubricant and the silicone lubricant may be used alone, or they may be used in combination.

The content of the lubricant in the lubricant solution (100 mass %) of the present invention is preferably from 0.01 to 50 mass %, more preferably from 0.005 to 30 mass %, further preferably from 0.1 to 20 mass %. When the content of the lubricant is within the above range, the film thickness of the coating film when the lubricant solution is applied, and the thickness of the lubricant coating film after drying are readily adjusted within proper ranges.

The lubricant solution of the present invention may contain, in addition to the lubricant and the solvent (A), components other than the lubricant and the solvent (A) within a range not to impair the effects of the present invention.

Such another component may, for example, be nitromethane, nitroethane, nitropropane, nitrobenzene, diethylamine, triethylamine, isopropylamine, diisopropylamine, butylamine, isobutylamine, tert-butylamine, α-picoline, N-methylbenzylamine, diallylamine, N-methylmorpholine, phenol, o-cresol, m-cresol, p-cresol, thymol, p-tert-butylphenol, tert-butylcatechol, catechol, isoeugenol, o-methoxyphenol, 4,4′-dihydroxyphenyl-2,2-propane, isoamyl salicylate, benzyl salicylate, methyl salicylate, 2,6-di-t-butyl-p-cresol, 2-(2′-hydroxy-5′-methylphenyl)benzotriazole, 2-(2′-hydroxy-3′-t-butyl-5′-methylphenyl)-5-chlorobenzotriazole, 1,2,3-benzotriazole, 1-[(N,N-bis-2-ethylhexyl)aminomethyl]benzotriazole, 1,2-propylene oxide, 1,2-butylene oxide, 1,4-dioxane, butyl glycidyl ether or phenyl glycidyl ether.

With the above-described lubricant solution of the present invention, which employs a solvent containing CFO-1214ya which has a short life in the air, which provides an excellent solubility of the lubricant and which has a sufficient drying property, a uniform lubricant coating film can easily be formed without impairing the global environment.

The lubricant solution of the present invention can be used for an object to be coated made of a wide variety of materials such as a metal, a plastic, an elastomer, glass and a ceramic, without impairing such materials. Particularly, drawbacks such as cracks or white turbidity are less likely to occur even on an object to be coated made of a synthetic resin such as an acrylic resin or a polycarbonate resin. Further, the lubricant solution of the present invention has a low viscosity and has a low surface tension and thus it can be applied thinly and uniformly to the surface of an object to be coated made of a metal.

<Method for Producing Article Provided with Lubricant Coating Film>

The method for producing an article provided with a lubricant coating film of the present invention is a method which comprises applying the lubricant solution of the present invention to an object to be coated, and evaporating the solvent (A) to form a lubricant coating film on the object.

The object to be coated may, for example, be an object to be coated made of various materials such as a metal, a plastic, an elastomer, glass and a ceramic.

For example, the article may be an industrial apparatus for which a fluorinated lubricant is used, a tray member for a CD or a DVD of a personal computer or audio instrument, household equipment and office automation equipment such as a printer, a copying machine or flux equipment. Further, the object may also be an injection needle or a cylinder of a syringe, a medical tube member, etc., for which a silicone lubricant is used.

The method of applying the lubricant solution of the present invention is not particularly limited and for example, application by a brush, application by spraying or application by immersing an object to be coated in the lubricant solution may be mentioned.

The method of drying the solvent (A) is not particularly limited and may, for example, be air drying.

The temperature for drying the solvent (A) is preferably from 20 to 100° C.

According to the above-described method for producing an article provided with a lubricant coating film of the present invention, since the lubricant solution of the present invention is used, an article provided with a lubricant coating film, which has a lubricant coating film, can easily be produced without impairing the global environment.

### EXAMPLES

Now, the present invention will be described in further detail with reference to Examples. However, it should be understood that the present invention is by no means restricted to such specific Examples. Ex. 1 is a Production Example, and Ex. 2 to 82 are Examples of the present invention.

### [Evaluation Method]

### 1. Disolution State

The dissolution state of the lubricant solution in each Ex. was visually confirmed and evaluated based on the following standards.

⊚ (excellent): The lubricant immediately dissolved uniformly and a transparent solution obtained.

◯ (good): The lubricant uniformly dissolved by shaking and a transparent solution obtained.

Δ (slightly good): The solution became slightly turbid.

x (bad): White turbidity or phase separation observed.

### 2. Coating Film State

The state of the lubricant coating film in each Ex. was visually confirmed and evaluated based on the following standards.

⊚ (excellent): Uniform coating film obtained.

◯ (good): Slightly uniform coating film obtained.

Δ (slightly bad): Partial unevenness on coating film observed.

x (bad): Significant unevenness observed on coating film.

### 3. Drying Property

The drying property of the lubricant solution when the lubricant coating film was formed in each Ex. was evaluated based on the following standards.

⊚ (excellent): The solvent immediately evaporated.

◯ (good): The solvent evaporated within 10 minutes.

Δ (pass): The solvent not evaporated within 10 minutes but evaporated within one hour.

x (bad): The solvent remained even after a lapse of 1 hour.

### Ex.1

### Production of CFO-1214ya

The method in Example 1 in WO2010/074254 was repeatedly carried out to obtain totally 3,900 g of 1,1-dichloro-2,3,3,3-tetrafluoro-1-propene (CFO-1214ya).

Specifically, into a glass reactor having an internal capacity of 1 L equipped with a Dimroth condenser cooled to 0° C., 3 g of tetrabutylammonium bromide as a phase transfer catalyst, 83 g (1.485 mol) of potassium hydroxide, 180 g of water and 609 g (3 mol) of “ASAHIKLIN AK-225”, tradename (manufactured by Asahi Glass Company, Limited, a mixture of 48 mol % of HCFC-225ca and 52 mol % of HCFC-225cb) were charged and gradually heated with stirring to carry out reaction at 45° C. for one hour. After the reaction, from a reaction crude liquid separated into two phases of an organic phase and an aqueous phase, the organic phase was separated and subjected to distillation by a distillation column having a capacity with a number of theoretical plates of 10 to obtain CFO-1214ya. This operation was repeated to obtain totally 3,900 g of

CFO-1214ya.

The purity of the obtained CFO-1214ya was 99.5 mass %, and the moisture content was 70 mass ppm. Further, dehydration treatment was carried out by Molecular Sieves 3A (manufactured by Union Carbide Corporation) to obtain CFO-1214ya having a moisture content of 3 mass ppm.

### Ex. 2

The solvent comprising CFO-1214ya obtained in Example 1 and “Krytox (registered trademark) GPL102”, tradename (manufactured by DuPont, fluorinated oil) which is a fluorinated lubricant were mixed to prepare a lubricant solution having a content of the fluorinated lubricant of 0.5 mass %.

Then, the obtained lubricant solution was applied to the surface of an aluminum-evaporated plate having aluminum evaporated on an iron plate, with an average thickness of about 0.4 mm and air dried at from 19 to 21° C. to form a lubricant coating film on the surface of the aluminum-evaporated plate.

### Ex. 3 to 34

A lubricant solution was prepared in the same manner as in Ex. 2 except that the composition of the solvent was changed as identified in Table 1. Then, a lubricant coating film was formed in the same manner as in Ex. 2.

The compositions of the solvents and the evaluation results in Ex. 2 to 34 are shown in Table 1. Abbreviations in Table 1 have the following meanings.

CFO-1214ya: 1,1-Dichloro-2,3,3,3-tetrafluoro-1-propene

NPEN: n-Pentane

CPEN: Cyclopentane

NHEX: n-Hexane

CHEX: Cyclohexane

NHEP: n-Heptane

MEOH: Methanol

ETOH: Ethanol

IPA: Isopropyl alcohol

ACE: Acetone

MEK: Methyl ethyl ketone

DEE: Diethyl ether

DIPE: Diisopropyl ether

THF: Tetrahydrofuran

MEAC: Methyl acetate

ETAC: Ethyl acetate

MC: Methylene chloride

TDCE: Trans-1,2-dichloroethylene

TCE: Trichloroethylene

HFC4310: 1,1,1,2,2,3,4,5,5,5-Decafluoropentane (tradename “Vertrel (registered trademark) XF”, manufactured by DuPont-Mitsui Fluorochemicals Company, Ltd.)

HFC569: 1,1,1,2,2,3,3,4,4-Nonafluorohexane (tradename “ASAHIKLIN AC-4000”, manufactured by Asahi Glass Company, Limited)

HFC5213: 1,1,1 ,2,2,3,3,4,4,5,5,6,6,-Tridecafluorohexane (tradename “ASAHIKLIN AC-2000”, manufactured by Asahi Glass Company, Limited)

HFE449: (Perfluorobutoxy)methane (tradename “Novec™7100”, manufactured by Sumitomo 3M Limited)

HFE347: 1,1,2,2-Tetrafluoro-1-(2,2,2-trifluoroethoxy)ethane (tradename “ASAHIKLIN AE-3000”, manufactured by Asahi Glass Company, Limited)

TABLE 1

| | Solvent composition | | Disso- | Coating | Drying |
|---|---|---|---|---|---|
| | | Mass | lution | film | prop- |
| | Type | ratio | state | state | erty |
| Ex. 2 | CFO-1214ya | 100 | ⊚ | ⊚ | ⊚ |
| Ex. 3 | CFO-1214ya/NPEN | 97/3 | ⊚ | ⊚ | ⊚ |
| Ex. 4 | CFO-1214ya/CPEN | 94/6 | ⊚ | ⊚ | ⊚ |
| Ex. 5 | CFO-1214ya/NHEX | 90/10 | ⊚ | ⊚ | ⊚ |
| Ex. 6 | CFO-1214ya/CHEX | 90/10 | ⊚ | ⊚ | ⊚ |
| Ex. 7 | CFO-1214ya/NHEP | 85/15 | ⊚ | ⊚ | ⊚ |
| Ex. 8 | CFO-1214ya/MEOH | 90/10 | ⊚ | ⊚ | ⊚ |
| Ex. 9 | CFO-1214ya/ETOH | 95/5 | ⊚ | ⊚ | ⊚ |
| Ex. 10 | CFO-1214ya/IPA | 97/3 | ⊚ | ⊚ | ⊚ |
| Ex. 11 | CFO-1214ya/ACE | 99/1 | ⊚ | ⊚ | ⊚ |
| Ex. 12 | CFO-1214ya/MEK | 97/3 | ⊚ | ⊚ | ⊚ |
| Ex. 13 | CFO-1214ya/DEE | 95/5 | ⊚ | ⊚ | ⊚ |
| Ex. 14 | CFO-1214ya/DIPE | 93/7 | ⊚ | ⊚ | ⊚ |
| Ex. 15 | CFO-1214ya/THF | 95/5 | ⊚ | ⊚ | ⊚ |
| Ex. 16 | CFO-1214ya/MEAC | 85/15 | ⊚ | ⊚ | ⊚ |
| Ex. 17 | CFO-1214ya/ETAC | 80/20 | ⊚ | ⊚ | ⊚ |
| Ex. 18 | CFO-1214ya/MC | 70/30 | ⊚ | ⊚ | ⊚ |
| Ex. 19 | CFO-1214ya/TDCE | 50/50 | ⊚ | ⊚ | ⊚ |
| Ex. 20 | CFO-1214ya/TCE | 80/20 | ⊚ | ⊚ | ⊚ |
| Ex. 21 | CFO-1214ya/HFC4310 | 70/30 | ⊚ | ⊚ | ⊚ |
| Ex. 22 | CFO-1214ya/HFC569 | 60/40 | ⊚ | ⊚ | ⊚ |
| Ex. 23 | CFO-1214ya/HFC5213 | 80/20 | ⊚ | ⊚ | ⊚ |
| Ex. 24 | CFO-1214ya/HFE449 | 60/40 | ⊚ | ⊚ | ⊚ |
| Ex. 25 | CFO-1214ya/HFE347 | 70/30 | ⊚ | ⊚ | ⊚ |
| Ex. 26 | CFO-1214ya/CHEX/ | 90/5/5 | ⊚ | ⊚ | ⊚ |
| | MEOH | | | | |
| Ex. 27 | CFO-1214ya/MEOH/ | 85/5/10 | ⊚ | ⊚ | ⊚ |
| | ETOH | | | | |
| Ex. 28 | CFO-1214ya/ACE/IPA | 92/3/5 | ⊚ | ⊚ | ⊚ |
| Ex. 29 | CFO-1214ya/THF/MEOH | 90/5/5 | ⊚ | ⊚ | ⊚ |
| Ex. 30 | CFO-1214ya/MEAC/ | 85/10/5 | ⊚ | ⊚ | ⊚ |
| | ETOH | | | | |
| Ex. 31 | CFO-1214ya/MC/MEOH | 60/35/5 | ⊚ | ⊚ | ⊚ |
| Ex. 32 | CFO-1214ya/TDCE/ | 50/45/5 | ⊚ | ⊚ | ⊚ |
| | ETOH | | | | |
| Ex. 33 | CFO-1214ya/HFC4310/ | 65/30/5 | ⊚ | ⊚ | ⊚ |
| | ETOH | | | | |
| Ex. 34 | CFO-1214ya/HFE449/ | 60/30/10 | ⊚ | ⊚ | ⊚ |
| | ETOH | | | | |

### Ex. 35 to 67

The composition of the solvent was changed as identified in Table 2, and the solvent was mixed with “Shin-Etsu Silicone KF-96-50CS”, tradename (manufactured by

Shin-Etsu Chemical Co., Ltd., silicone oil) which is a silicone oil to prepare a lubricant solution having a content of the silicone lubricant of 3 mass %. Then, a lubricant coating film was formed in the same manner as in Ex. 2.

The compositions of the solvents and the evaluation results in Ex. 35 to 67 are shown in Table 2. The abbreviations in Table 2 have the same meanings as the abbreviations in Table 1.

TABLE 2

| | Solvent composition | | Disso- | Coating | Drying |
|---|---|---|---|---|---|
| | | Mass | lution | film | prop- |
| | Type | ratio | state | state | erty |
| Ex. 35 | CFO-1214ya | 100 | ⊚ | ⊚ | ⊚ |
| Ex. 36 | CFO-1214ya/NPEN | 97/3 | ⊚ | ⊚ | ⊚ |
| Ex. 37 | CFO-1214ya/CPEN | 94/6 | ⊚ | ⊚ | ⊚ |
| Ex. 38 | CFO-1214ya/NHEX | 90/10 | ⊚ | ⊚ | ⊚ |
| Ex. 39 | CFO-1214ya/CHEX | 90/10 | ⊚ | ⊚ | ⊚ |
| Ex. 40 | CFO-1214ya/NHEP | 85/15 | ⊚ | ⊚ | ⊚ |
| Ex. 41 | CFO-1214ya/MEOH | 90/10 | ⊚ | ⊚ | ⊚ |
| Ex. 42 | CFO-1214ya/ETOH | 95/5 | ⊚ | ⊚ | ⊚ |
| Ex. 43 | CFO-1214ya/IPA | 97/3 | ⊚ | ⊚ | ⊚ |
| Ex. 44 | CFO-1214ya/ACE | 99/1 | ⊚ | ⊚ | ⊚ |
| Ex. 45 | CFO-1214ya/MEK | 97/3 | ⊚ | ⊚ | ⊚ |
| Ex. 46 | CFO-1214ya/DEE | 95/5 | ⊚ | ⊚ | ⊚ |
| Ex. 47 | CFO-1214ya/DIPE | 93/7 | ⊚ | ⊚ | ⊚ |
| Ex. 48 | CFO-1214ya/THF | 95/5 | ⊚ | ⊚ | ⊚ |
| Ex. 49 | CFO-1214ya/MEAC | 85/15 | ⊚ | ⊚ | ⊚ |
| Ex. 50 | CFO-1214ya/ETAC | 80/20 | ⊚ | ⊚ | ⊚ |
| Ex. 51 | CFO-1214ya/MC | 70/30 | ⊚ | ⊚ | ⊚ |
| Ex. 52 | CFO-1214ya/TDCE | 50/50 | ⊚ | ⊚ | ⊚ |
| Ex. 53 | CFO-1214ya/TCE | 80/20 | ⊚ | ⊚ | ⊚ |
| Ex. 54 | CFO-1214ya/HFC4310 | 70/30 | ⊚ | ⊚ | ⊚ |
| Ex. 55 | CFO-1214ya/HFC569 | 60/40 | ⊚ | ⊚ | ⊚ |
| Ex. 56 | CFO-1214ya/HFC5213 | 80/20 | ⊚ | ⊚ | ⊚ |
| Ex. 57 | CFO-1214ya/HFE449 | 60/40 | ⊚ | ⊚ | ⊚ |
| Ex. 58 | CFO-1214ya/HFE347 | 70/30 | ⊚ | ⊚ | ⊚ |
| Ex. 59 | CFO-1214ya/CHEX/ | 90/5/5 | ⊚ | ⊚ | ⊚ |
| | MEOH | | | | |
| Ex. 60 | CFO-1214ya/MEOH/ | 85/5/10 | ⊚ | ⊚ | ⊚ |
| | ETOH | | | | |
| Ex. 61 | CFO-1214ya/ACE/IPA | 92/3/5 | ⊚ | ⊚ | ⊚ |
| Ex. 62 | CFO-1214ya/THF/MEOH | 90/5/5 | ⊚ | ⊚ | ⊚ |
| Ex. 63 | CFO-1214ya/MEAC/ | 85/10/5 | ⊚ | ⊚ | ⊚ |
| | ETOH | | | | |
| Ex. 64 | CFO-1214ya/MC/MEOH | 60/35/5 | ⊚ | ⊚ | ⊚ |
| Ex. 65 | CFO-1214ya/TDCE/ | 50/45/5 | ⊚ | ⊚ | ⊚ |
| | ETOH | | | | |
| Ex. 66 | CFO-1214ya/HFC4310/ | 65/30/5 | ⊚ | ⊚ | ⊚ |
| | ETOH | | | | |
| Ex. 67 | CFO-1214ya/HFE449/ | 60/30/10 | ⊚ | ⊚ | ⊚ |
| | ETOH | | | | |

### Ex. 68 to 82

The composition of the solvent was changed as identified in Table 3, and the solvent was mixed with “Krytox (registered trademark) GPL102”, tradename (manufactured by DuPont, fluorinated oil) and “Fluon (registered trademark) PTFE L150J”, tradename (manufactured by Asahi Glass Company, Limited, polytetrafluoroethylene resin powder, average primary particle size: 9 μm) which are fluorinated lubricants to prepare a lubricant solution which has a content of the fluorinated oil of 0.5 mass % and a content of the polytetrafluoroethylene resin powder of 0.1 mass %.

Then, the obtained lubricant solution was applied to the surface of a polycarbonate plate with an average thickness of about 0.5 mm and air dried at from 20 to 21° C. to form a lubricant coating film on the surface of the polycarbonate plate. The compositions of solvents and the evaluation results in Ex. 68 to 82 are shown in Table 3. The abbreviations in Table 3 have the same meanings as the abbreviations in Table 1.

TABLE 3

| | Solvent composition | | | |
|---|---|---|---|---|
| | | Mass | Coating film | Drying |
| | Type | ratio | state | property |
| Ex. 68 | CFO-1214ya | 100 | ⊚ | ⊚ |
| Ex. 69 | CFO-1214ya/NPEN | 97/3 | ⊚ | ⊚ |
| Ex. 70 | CFO-1214ya/CPEN | 94/6 | ⊚ | ⊚ |
| Ex. 71 | CFO-1214ya/ETOH | 95/5 | ⊚ | ⊚ |
| Ex. 72 | CFO-1214ya/IPA | 97/3 | ⊚ | ⊚ |
| Ex. 73 | CFO-1214ya/ACE | 99/1 | ⊚ | ⊚ |
| Ex. 74 | CFO-1214ya/MEK | 97/3 | ⊚ | ⊚ |
| Ex. 75 | CFO-1214ya/DEE | 95/5 | ⊚ | ⊚ |
| Ex. 76 | CFO-1214ya/DIPE | 93/7 | ⊚ | ⊚ |
| Ex. 77 | CFO-1214ya/HFC4310 | 70/30 | ⊚ | ⊚ |
| Ex. 78 | CFO-1214ya/HFC569 | 60/40 | ⊚ | ⊚ |
| Ex. 79 | CFO-1214ya/HFC5213 | 80/20 | ⊚ | ⊚ |
| Ex. 80 | CFO-1214ya/HFE449 | 60/40 | ⊚ | ⊚ |
| Ex. 81 | CFO-1214ya/HFE347 | 70/30 | ⊚ | ⊚ |
| Ex. 82 | CFO-1214ya/HFC4310/ETOH | 65/30/5 | ⊚ | ⊚ |

As shown in Tables 1 to 3, with the lubricant solutions of the present invention in Ex. 2 to 82, which provided excellent solubility of the lubricant and had a sufficient drying property, a uniform lubricant coating film could easily be formed.

### INDUSTRIAL APPLICABILITY

The lubricant solution of the present invention is excellent in the solubility of the lubricant and the drying property, is capable of forming a uniform lubricant coating film and can be used for an object to be coated made of various materials such as a metal, a plastic and an elastomer, without impairing the object.

This application is a continuation of PCT Application No. PCT/JP2013/061675, filed on Apr. 19, 2013, which is based upon and claims the benefit of priority from Japanese Patent Application No. 2012-097857 filed on Apr. 23, 2012. The contents of those applications are incorporated herein by reference in their entireties.

What is claimed is:

1. A lubricant solution which is a solution of a lubricant, wherein the solvent is a solvent containing 1,1-dichloro-2,3,3,3-tetrafluoro-1-propene.

2. The lubricant solution according to claim 1, wherein the lubricant is a fluorinated lubricant or a silicone lubricant.

3. The lubricant solution according to claim 1, wherein the content of the solvent in the lubricant solution is from 50 to 99.99 mass %.

4. The lubricant solution according to claim 1, wherein the solvent comprises 1,1-dichloro-2,3,3,3-tetrafluoro-1-propene and an organic solvent soluble in 1,1-dichloro-2,3,3,3-tetrafluoro-1-propene.

5. The lubricant solution according to claim 4, wherein the organic solvent is an organic solvent selected from the group consisting of a hydrocarbon, an alcohol, a ketone, an ether, an ester, a chlorocarbon, a hydrofluorocarbon and a hydrofluoroether.

6. The lubricant solution according to claim 5, wherein the hydrocarbon is n-pentane, cyclopentane, n-hexane, cyclohexane or n-heptane.

7. The lubricant solution according to claim 5, wherein the alcohol is methanol, ethanol or isopropyl alcohol.

8. The lubricant solution according to claim 5, wherein the ketone is acetone or methyl ethyl ketone.

9. The lubricant solution according to claim 5, wherein the ether is diethyl ether, diisopropyl ether or tetrahydrofuran.

10. The lubricant solution according to claim 5, wherein the ester is methyl acetate or ethyl acetate.

11. The lubricant solution according to claim 5, wherein the chlorocarbon is methylene chloride, trans-1,2-dichloroethylene or trichloroethylene.

12. The lubricant solution according to claim 5, wherein the hydrofluorocarbon is 1,1,1,2,2,3,4,5,5,5-decafluoropentane, 1,1,1,2,2,3,3,4,4-nonafluorohexane or 1,1,1,2,2,3,3,4,4,5,5,6,6-tridecafluorohexane.

13. The lubricant solution according to claim 5, wherein the hydrofluoroether is (perfluorobutoxy)methane or 1,1,2,2-tetrafluoro-1-(2,2,2-trifluoroethoxy)ethane.

14. The lubricant solution according to claim 4, wherein the content of the organic solvent in the solvent is from 0.1 to 50 mass %.

15. A method for producing an article provided with a lubricant coating film, which comprises applying the lubricant solution as defined in claim 1 to an object to be coated, and evaporating the solvent to form a lubricant coating film on the object.
